(19) United States
(12) Patent Application Publication
(10) Pub. No.: US 2016/0088413 A1
(43) Pub. Date: Mar. 24, 2016

(54) CENTER POSITIONING JIG AND SPEAKER ASSEMBLING METHOD USING THE SAME

(71) Applicant: MERRY ELECTRONICS (SUZHOU) CO., LTD., Suzhou City (CN)

(72) Inventors: Wen-Hong WANG, Taichung City (TW); Chia-Chi LAI, Taichung City (TW)

(21) Appl. No.: 14/491,330

(22) Filed: Sep. 19, 2014

(51) Int. Cl. H04R 31/00

(52) U.S. Cl. CPC H04R 31/00

(57) ABSTRACT

A center positioning jig includes a base having a top surface and an annular groove wherein the top surface has central and peripheral sections separated by the annular groove, and a positioning column protruding from the central section. The center positioning jig is adapted for assembling a speaker in a way that a voice coil is combined with a positioning sheet by means of the center positioning jig and a voice coil jig or just sleeved onto the voice coil jig, a magnetic path structure is constructed of a magnet-conductive housing, a magnetic element and a magnet-conductive plate and then combined with the voice coil and a diaphragm by means of the center positioning jig, and a cap is fastened to the diaphragm. In this way, the assembly of the speaker requires relatively fewer jigs and the components of the speaker are easy to be combined coaxially.

### BACKGROUND OF THE INVENTION

1. Field of the Invention

The present invention relates generally to speaker assembling methods and more particularly, to a center positioning jig and a speaker assembling method using the same.

2. Description of the Related Art

Taiwan Patent No. 1325730 disclosed a micro-speaker which is adapted for an earphone or a cellphone, and the micro-speaker comprises a half-voice combination and a half-housing combination. The half-voice combination comprises a diaphragm, a ring which is made of rubber in the aforesaid patent for supporting the periphery of the diaphragm, and a voice coil connected with the diaphragm. The half-housing combination comprises iron housing, a magnet disposed in the iron housing and fastened to a bottom wall thereof, and an iron sheet fastened to the magnet. In the aforesaid patent, the diaphragm, the rubber ring and the voice coil are combined together to form the half-voice combination by means of a jig and a top cover for the jig. After that, the half-voice combination is combined with the half-housing combination coaxially by means of the same jig. However, before the half-voice combination and the half-housing combination are combined together, the iron housing, the magnet and the iron sheet should be combined together to form the half-housing combination by means of another jig.

In other words, the assembly of the aforesaid micro-speaker requires two different jigs and a top cover for one of the jigs and therefore causes high cost. Besides, in order that all components of the micro-speaker would be combined coaxially, the jigs and the top cover should be manufactured so accurately as to have a high coaxiality.

### SUMMARY OF THE INVENTION

The present invention has been accomplished in view of the above-noted circumstances. It is an objective of the present invention to provide a center positioning jig and a speaker assembling method using the same, by which the assembly of the speaker requires relatively fewer jigs and lower cost. Furthermore, the components of the speaker are easy to be combined coaxially.

To attain the above objective, the present invention provides a center positioning jig which comprises a base and a positioning column. The base has a top surface and an annular groove concaved from the top surface. The top surface has a central section surrounded by the annular groove and a peripheral section surrounding the annular groove. The positioning column protrudes from the central section of the top surface of the base.

To attain the above objective, the present invention provides a speaker assembling method using the aforesaid center positioning jig, which comprises the steps of:

a. combining a positioning sheet and a voice coil to form a voice coil structure by means of the center positioning jig and a voice coil jig. Wherein the voice coil is positioned on the voice coil jig beforehand, the positioning sheet and the voice coil along with the voice coil jig are sleeved onto the positioning column in order, then the voice coil jig is removed from the voice coil when he positioning sheet is fastened to the voice coil;

b. combining a magnet-conductive housing, a magnetic element and a magnet-conductive plate to form a magnetic path structure by means of the center positioning jig in a way that the magnet-conductive housing, the magnetic element and the magnet-conductive plate are sleeved onto the positioning column in order, and then removing the center positioning jig from the magnetic path structure;

c. disposing a diaphragm, which has a central part, a surround surrounding the central part and a hole located at the central part, on the top surface of the base in a way that the positioning column passes through the hole, the central part is located at the central section of the top surface of the base, and the surround is located at the annular groove of the base;

d. putting the voice coil structure around the positioning column and fastening the positioning sheet to the central part of the diaphragm;

e. putting the magnetic path structure around the positioning column and combining the magnetic path structure with the diaphragm;

f. removing the center positioning jig from the diaphragm; and

g. fastening a cap at the hole of the diaphragm.

To attain the above objective, the present invention provides another speaker assembling method using the aforesaid center positioning jig, which comprises the steps of:

a. disposing a voice coil on a voice coil jig in a way that the voice coil is sleeved onto the voice coil jig and a center hole of the voice coil jig is located at the center of the voice coil;

b. combining a magnet-conductive housing, a magnetic element and a magnet-conductive plate to form a magnetic path structure by means of the center positioning jig in a way that the magnet-conductive housing, the magnetic element and the magnet-conductive plate are sleeved onto the positioning column in order, and then removing the center positioning jig from the magnetic path structure;

c. disposing a diaphragm, which has a central part, a surround surrounding the central part and a hole located at the central part, on the top surface of the base in a way that the positioning column passes through the hole, the central part is located at the central section of the top surface of the base, and the surround is located at the annular groove of the base;

d. putting the voice coil along with the voice coil jig around the positioning column, fastening the voice coil to the central part of the diaphragm, and then removing the voice coil jig from the voice coil;

e. putting the magnetic path structure around the positioning column and combining the magnetic path structure with the diaphragm;

f. removing the center positioning jig from the diaphragm; and

g. fastening a cap at the hole of the diaphragm.

The aforesaid speaker assembling methods differ from each other only in the step a and the step d. The speaker assembled through the former speaker assembling method has said positioning sheet, but the speaker assembled through the latter speaker assembling method doesn't.

As a result, the speaker assembling methods of the present invention require only two jigs, i.e. the center positioning jig and the voice coil jig, which are simple in configuration and easily manufactured so as to cause relatively lower jig cost. Besides, in the speaker assembling methods of the present invention, the surround of the diaphragm can be positioned in accordance with the annular groove of the center positioning jig and the center holes of other components can be positioned in accordance with the positioning column of the center positioning jig so that the components of the speaker are easy to be combined coaxially.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 and FIG. 2 are respectively a schematic tridimensional view and a schematic sectional view of a center positioning jig according to a first preferred embodiment of the present invention;

FIGS. 3-6 are schematic sectional views illustrating the process of the step a of a speaker assembling method according to the first preferred embodiment of the present invention;

FIG. 7 is a schematic tridimensional view of a voice coil structure assembled in the step a of the speaker assembling method according to the first preferred embodiment of the present invention;

FIGS. 8-10 are schematic sectional views illustrating the process of the step b of the speaker assembling method according to the first preferred embodiment of the present invention;

FIG. 11 is a schematic tridimensional view of a magnetic path structure assembled in the step b of the speaker assembling method according to the first preferred embodiment of the present invention;

FIGS. 12-15 are schematic sectional views illustrating the process of the step c to the step g of the speaker assembling method according to the first preferred embodiment of the present invention;

FIG. 16 is a schematic tridimensional view of a speaker assembled in the process of the speaker assembling method according to the first preferred embodiment of the present invention;

FIG. 17 is a schematic sectional view of a speaker assembled in the process of a speaker assembling method according to a second preferred embodiment of the present invention;

FIG. 18 is a schematic sectional view illustrating the step d of the speaker assembling method according to the second preferred embodiment of the present invention;

FIG. 19 is a schematic tridimensional view of a center positioning jig according to a third preferred embodiment of the present invention;

FIG. 20 is a schematic tridimensional view of a center positioning jig according to a fourth preferred embodiment of the present invention; and

FIG. 21 is a schematic tridimensional view of a center positioning jig according to a fifth preferred embodiment of the present invention.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention.

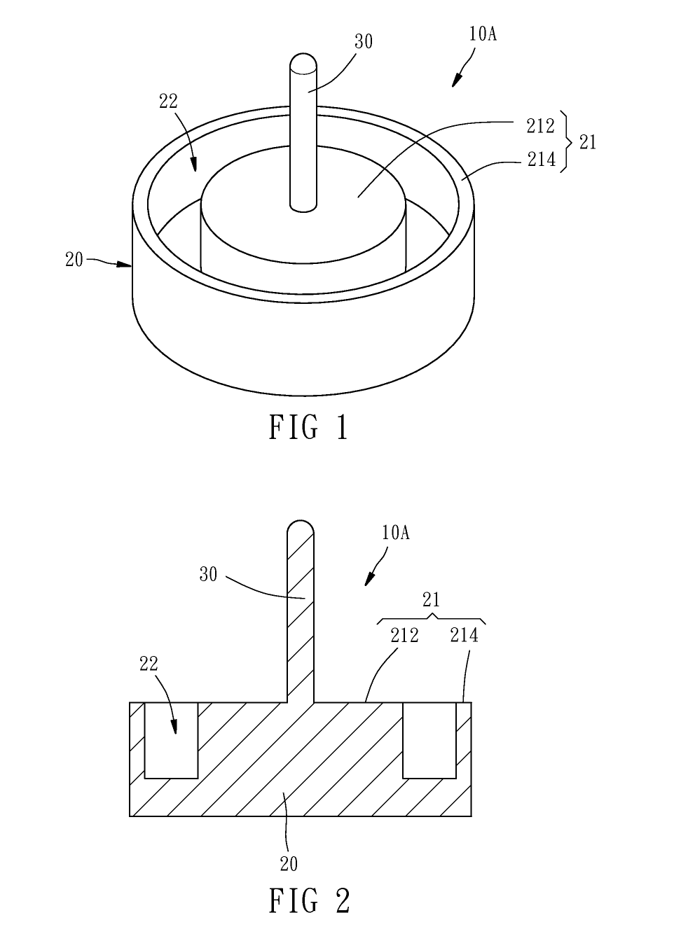

Referring to FIGS. 1-2, a center positioning jig 10A according to a first preferred embodiment of the present invention comprises a base 20 which is approximately shaped as a cylinder with a larger radius, and a positioning column 30 which is shaped as a cylinder with a smaller radius.

The base 20 has a top surface 21 and an annular groove 22 concaved from the top surface 21. The top surface 21 has a circular central section 212 surrounded by the annular groove 22, and an annular peripheral section 214 surrounding the annular groove 22. The positioning column 30 protrudes from the center of the central section 212 and is thereby located at the center of the annular groove 22 and the center of the peripheral section 214.

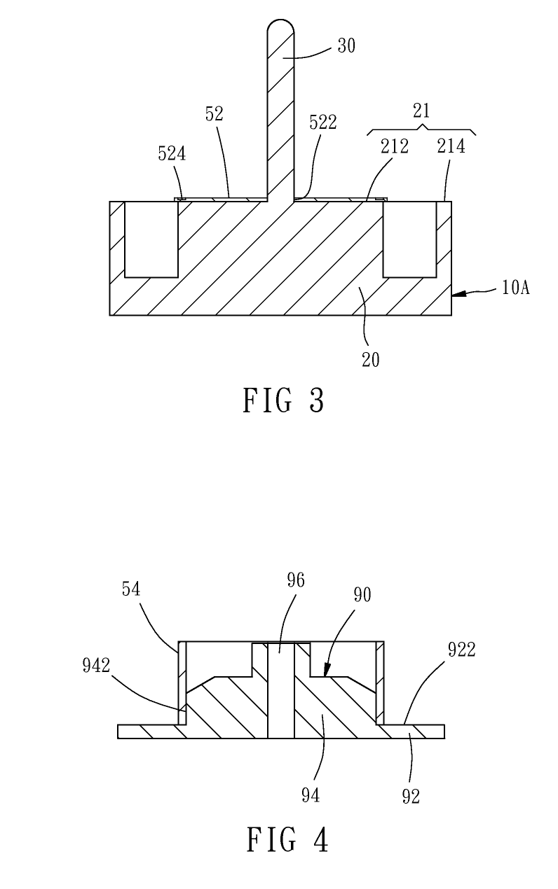

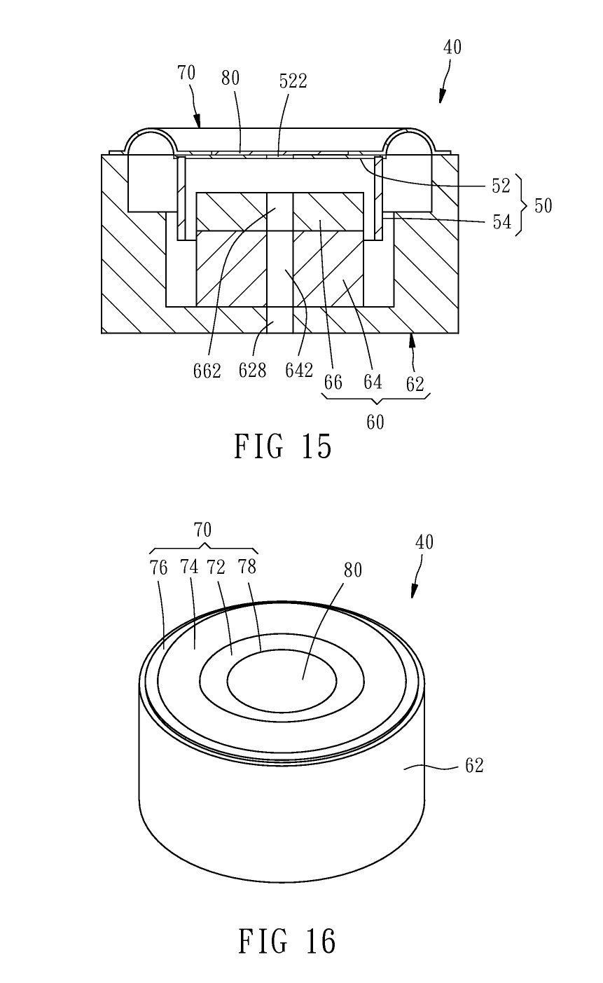

FIGS. 3-16 illustrate the process of a speaker assembling method which is adapted for assembling a speaker 40 as shown in FIGS. 15-16 by means of the center positioning jig 10A. The speaker 40 comprises a voice coil structure 50, a magnetic path structure 60, a diaphragm 70 and a cap 80.

The voice coil structure 50 comprises a positioning sheet 52 and a voice coil 54. The positioning sheet 52 may, but not limited to, be a circular sheet made of plastics and is a little larger than the central section 212 of the top surface 21 of the base 20. In addition, the positioning sheet 52 is provided at the center thereof with a center hole 522 just for the positioning column 30 to pass through. The voice coil 54 is a coil made of a wound electric wire.

The magnetic path structure 60 comprises a magnet-conductive housing 62, a magnetic element 64 and a magnet-conductive plate 66. The magnet-conductive housing 62 is made of a magnet-conductive material, such as iron. The magnetic element 64 is a cylindrical magnet provided at the center thereof with a center hole 642 just for the positioning column 30 to pass through. The magnet-conductive plate 66 is a circular plate made of a magnet-conductive material, such as iron, and provided at the center thereof with a center hole 662 just for the positioning column 30 to pass through.

The speaker assembling method comprises the following steps a-g which could proceed in order. However, the order of some steps of the speaker assembling method can be exchanged.

a. As shown in FIGS. 3-7, combine the positioning sheet 52 and the voice coil 54 to form the voice coil structure 50 by means of the center positioning jig 10A and a voice coil jig 90. The voice coil jig 90 has a bottom plate 92, a pillar 94 protruding from a top surface 922 of the bottom plate 92, and a center hole 96 penetrating the bottom plate 92 and the pillar 94. The pillar 94 has a cylindrical surface 942 which is concentric with the center hole 96. The step a comprises the following steps a1-a4.

a1. As shown in FIG. 3, dispose the positioning sheet 52 on the central section 212 of the top surface 21 of the base 20 in a way that the positioning column 30 passes through the center hole 522 of the positioning sheet 52.

a2. As shown in FIG. 4, dispose the voice coil 54 on the voice coil jig 90 in a way that the voice coil 54 is sleeved onto the voice coil jig 90 and the center hole 96 of the voice coil jig 90 is located at the center of the voice coil 54. Specifically speaking, in the step a2 the voice coil 54 is temporarily fixed at the cylindrical surface 942 of the voice coil jig 90 and abutted against the top surface 922 of the bottom plate 92 so as to be ensured being concentric with the center hole 96. The order of step a1 and step a2 can be exchanged.

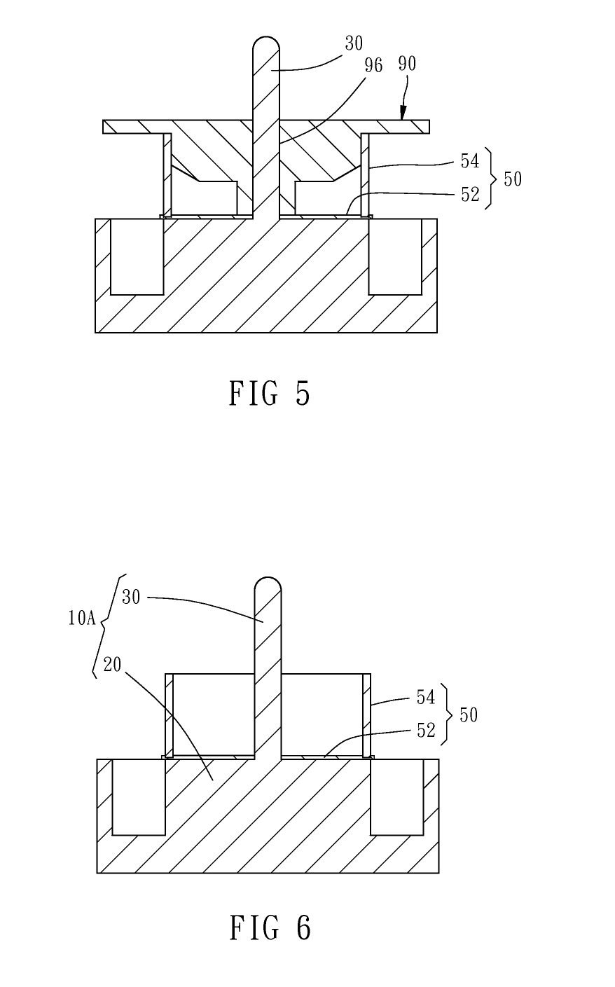

a3. As shown in FIG. 5, put the voice coil 54 around the positioning column 30 in a way that the positioning column 30 passes through the center hole 96 of the voice coil jig 90, and fasten the voice coil 54 to the positioning sheet 52. Specifically speaking, in the step a3 the apparatus shown in FIG. 3 is combined with the apparatus shown in FIG. 4 and the center hole 96 of the voice coil jig 90 is positioned in accordance with the positioning column 30 so that the voice coil 54 is disposed on the positioning sheet 52 coaxially. After that, the positioning sheet 52 and the voice coil 54 are glued together to form the voice coil structure 50.

In this embodiment, the positioning sheet 52 has an annular embedding groove 524 surrounding the center hole 522, as shown in FIG. 3, and the voice coil 54 is fixedly embedded in the embedding groove 524. In this way, the voice coil 54 is fastened to the positioning sheet 52 relatively more firmly. However, the positioning sheet 52 is not limited to have the embedding groove 524.

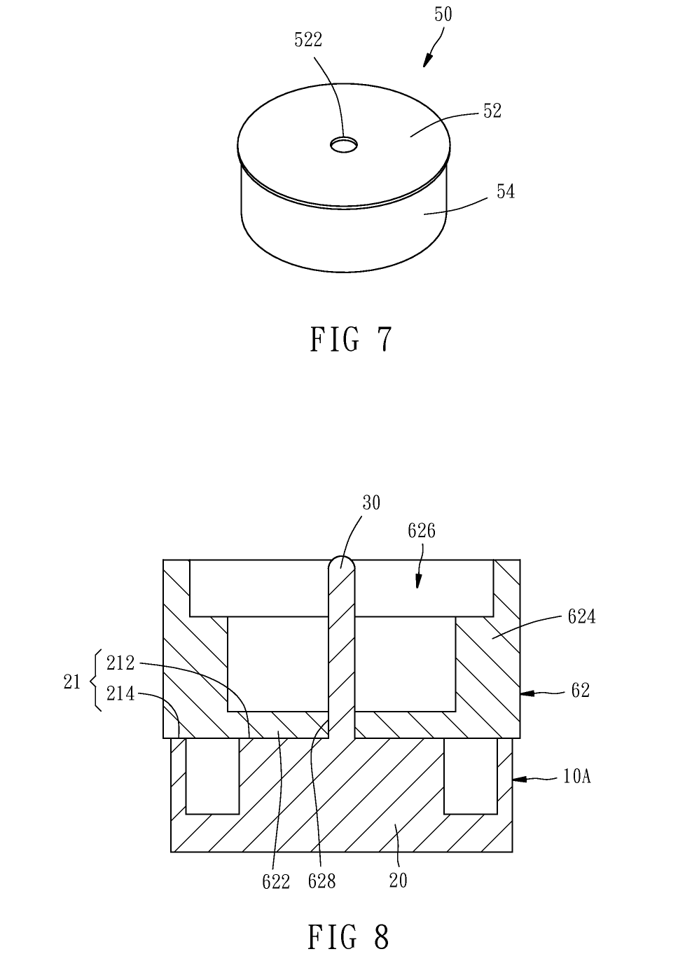

a4. Remove the voice coil jig 90 from the voice coil structure 50, as shown in FIG. 6, and remove the voice coil structure 50 from the center positioning jig 10A, as shown in FIG. 7.

b. As shown in FIGS. 8-11, combine the magnet-conductive housing 62, the magnetic element 64 and the magnet-conductive plate 66 to form the magnetic path structure 60 by means of the center positioning jig 10A. The step b comprises the following steps b1-b4.

b1. As shown in FIG. 8, dispose the magnet-conductive housing 62 on the top surface 21 of the base 20. The magnet-conductive housing 62 has a bottom wall 622, an enclosing side wall 624, an accommodating space 626 defined by the bottom wall 622 and the enclosing side wall 624, and a center hole 628 located at the bottom wall 622. The positioning column 30 passes through the center hole 628 of the magnet-conductive housing 62.

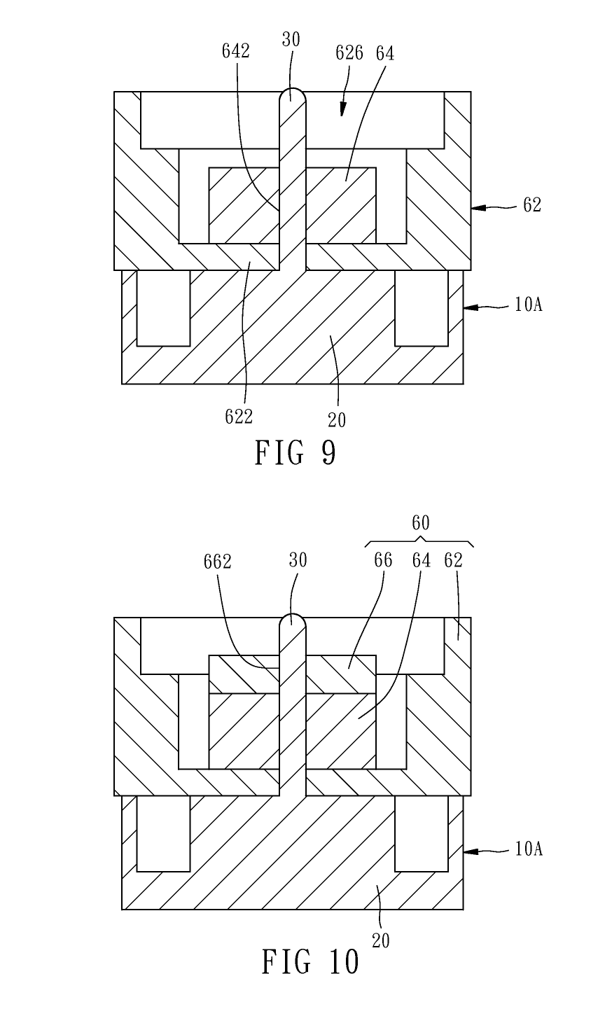

b2. As shown in FIG. 9, dispose the magnetic element 64 in the accommodating space 626 of the magnet-conductive housing 62 in a way that the positioning column 30 passes through the center hole 642 of the magnetic element 64, and fasten the magnetic element 64 to the bottom wall 622.

b3. As shown in FIG. 10, fasten the magnet-conductive plate 66 to the magnetic element 64 in a way that the positioning column 30 passes through the center hole 662 of the magnet-conductive plate 66.

Specifically speaking, in the aforesaid steps b1-b3 the center holes 628, 642, 662 of the magnet-conductive housing 62, the magnetic element 64 and the magnet-conductive plate 66 are positioned in accordance with the positioning column 30 so that the magnet-conductive housing 62, the magnetic element 64 and the magnet-conductive plate 66 are disposed coaxially. Besides, the magnetic element 64 is glued to the magnet-conductive housing 62 and the magnet-conductive plate 66 is glued to the magnetic element 64 to form the magnetic path structure 60.

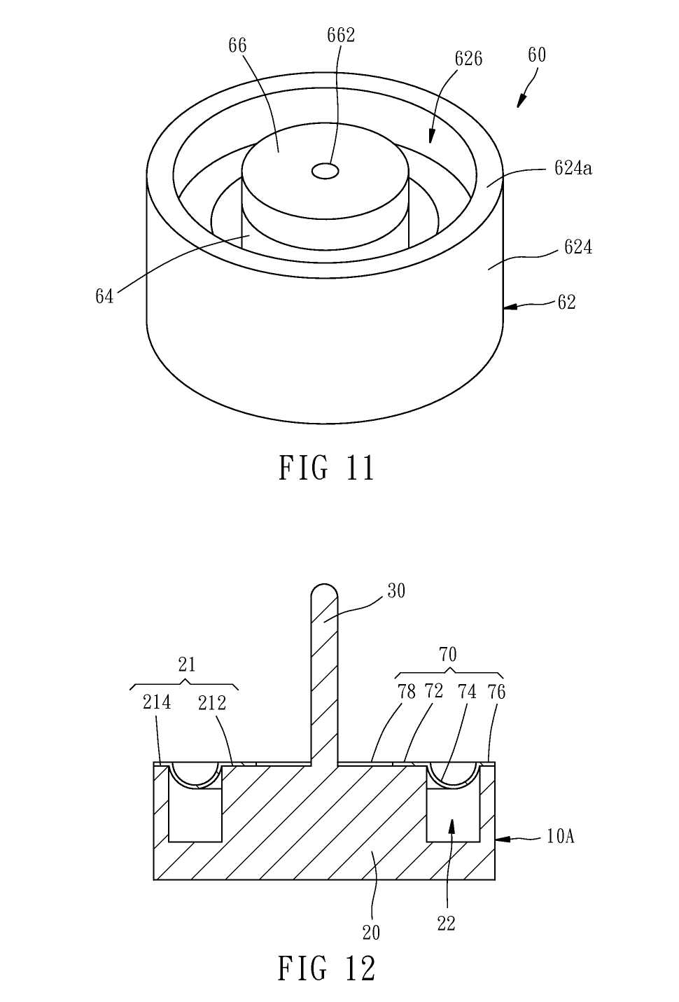

b4. Remove the magnetic path structure 60 from the center positioning jig 10A, as shown in FIG. 11. The order of the aforesaid step a and step b can be exchanged. Alternatively, the step a and the step b can proceed at the same time by means of two center positioning jigs 10A respectively so as to save time for assembling the speaker.

c. As shown in FIG. 12, dispose the diaphragm 70 on the top surface 21 of the base 20. The diaphragm 70 has a central part 72, a surround 74 surrounding the central part 72 and having arched cross-sections, a supporting part 76 surrounding the surround 74, and a hole 78 located at the central part 72. The positioning column 30 passes through the hole 78. The central part 72 and the supporting part 76 are located at the central section 212 and the peripheral section 214 of the top surface 21 of the base 20, respectively. The surround 74 is located at the annular groove 22 of the base 20. In the step c the diaphragm 70 is positioned on the center positioning jig 10A in a way that the surround 74 of the diaphragm 70 is positioned in accordance with the annular groove 22 of the base 20 so that the positioning column 30 is located at the center of the diaphragm 70.

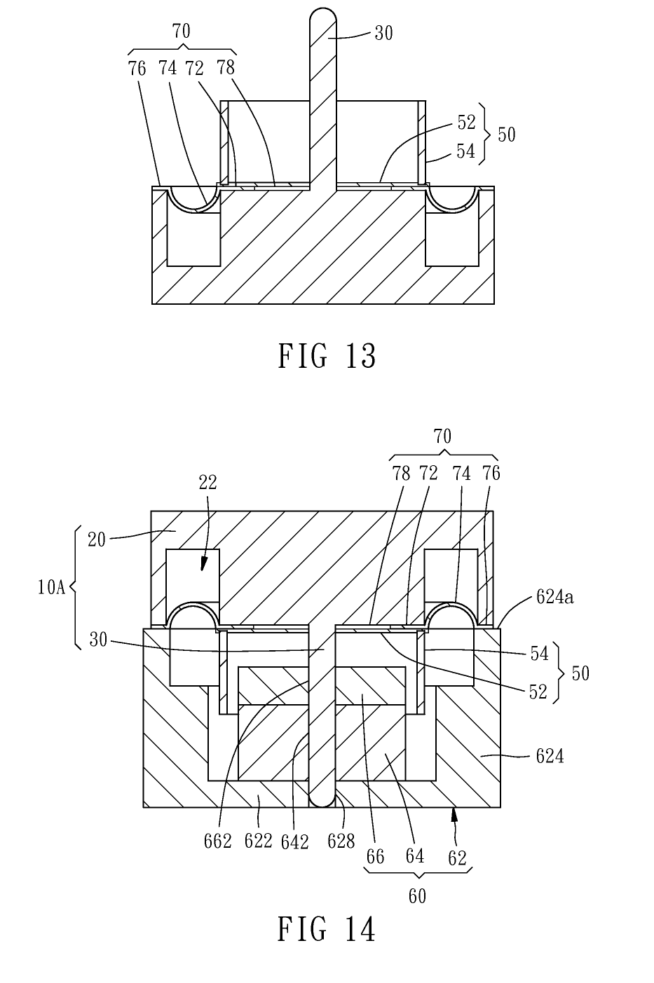

d. As shown in FIG. 13, put the voice coil structure 50 around the positioning column 30 in a way that the positioning column 30 passes through the center hole 522 of the positioning sheet 52, and fasten the positioning sheet 52 to the central part 72 of the diaphragm 70. Specifically speaking, in the step d the voice coil structure 50 assembled in the aforesaid step a is disposed on the apparatus shown in FIG. 12 and the center hole 522 of the positioning sheet 52 is positioned in accordance with the positioning column 30 so that the voice coil structure 50 is disposed on the diaphragm 70 coaxially. After that, the positioning sheet 52 and the diaphragm 70 are glued together.

e. As shown in FIG. 14, put the magnetic path structure 60 around the positioning column 30 in a way that the positioning column 30 passes through the center holes 662, 642, 628 of the magnet-conductive plate 66, the magnetic element 64 and the magnet-conductive housing 62 in order, and fasten the top edge 624a of the enclosing side wall 624 of the magnet-conductive housing 62 to the supporting part 76 of the diaphragm 70. Specifically speaking, in the step e the magnetic path structure 60 assembled in the aforesaid step b is combined with the apparatus shown in FIG. 13 and the center holes 662, 642, 628 of the magnetic path structure 60 are positioned in accordance with the positioning column 30 so that the magnetic path structure 60 is disposed on the diaphragm 70 coaxially. After that, the magnet-conductive housing 62 and the diaphragm 70 are glued together.

f. Remove the center positioning jig 10A from the diaphragm 70.

g. Fasten the cap 80 at the hole 78 of the diaphragm 70, as shown in FIGS. 15-16. The cap 80 is adapted to fill the hole 78 of the diaphragm 70 and cover the center hole 522 of the positioning sheet 52. In the circumstances, the assembly of the speaker 40 is accomplished.

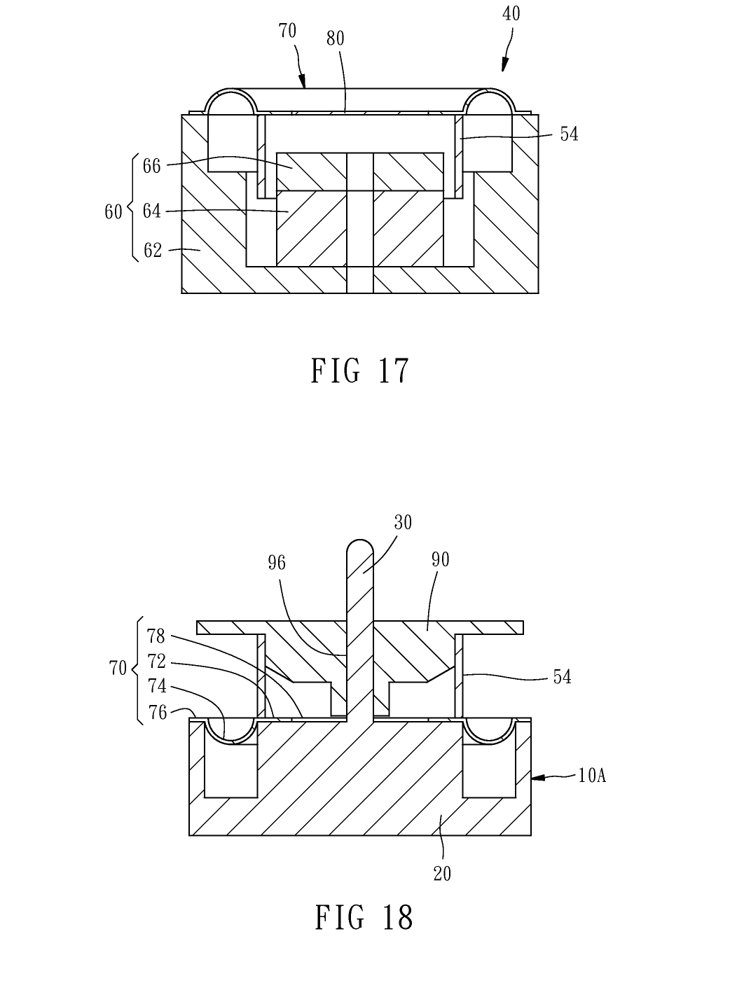

It will be appreciated that the positioning sheet 52 has the effect of supporting the diaphragm 70; however, the speaker in the present invention may have no such positioning sheet 52, such as a speaker 40′ according to a second preferred embodiment of the present invention as shown in FIG. 17. In this case, the method of assembling the speaker 40′ is similar to the aforesaid speaker assembling method but different from it in the step a and the step d. In the step a of this embodiment, the voice coil 54 is sleeved onto the voice coil jig 90 and the center hole 96 of the voice coil jig 90 is located at the center of the voice coil 54, as shown in FIG. 4. In the step d of this embodiment, the positioning column 30 passes through the center hole 96 of the voice coil jig 90 and the voice coil 54 is fastened to the central part 72 of the diaphragm 72, as shown in FIG. 18; after that, the voice coil jig 90 is removed from the voice coil 54.

In other words, the method of assembling the speaker 40′ is almost the same with the aforesaid method of assembling the speaker 40 except for the step a and the step d. Besides, the step a of the method of assembling the speaker 40′ is the same with the aforesaid step a2 included in the step a of the method of assembling the speaker 40. The other steps included in the step a of the method of assembling the speaker 40 are related to the center positioning jig 10A and the positioning sheet 52 and therefore not included in the method of assembling the speaker 40′.

According to the above content, the speaker assembling methods of the present invention require only two jigs, i.e. the center positioning jig 10A and the voice coil jig 90, which are simple in configuration and easily manufactured so as to cause relatively lower jig cost. Besides, in the speaker assembling methods of the present invention, the surround 74 of the diaphragm 70 can be positioned in accordance with the annular groove 22 of the center positioning jig 10A and the center holes of other components can be positioned in accordance with the positioning column 30 of the center positioning jig 10A so that the components of the speaker are easy to be combined coaxially.

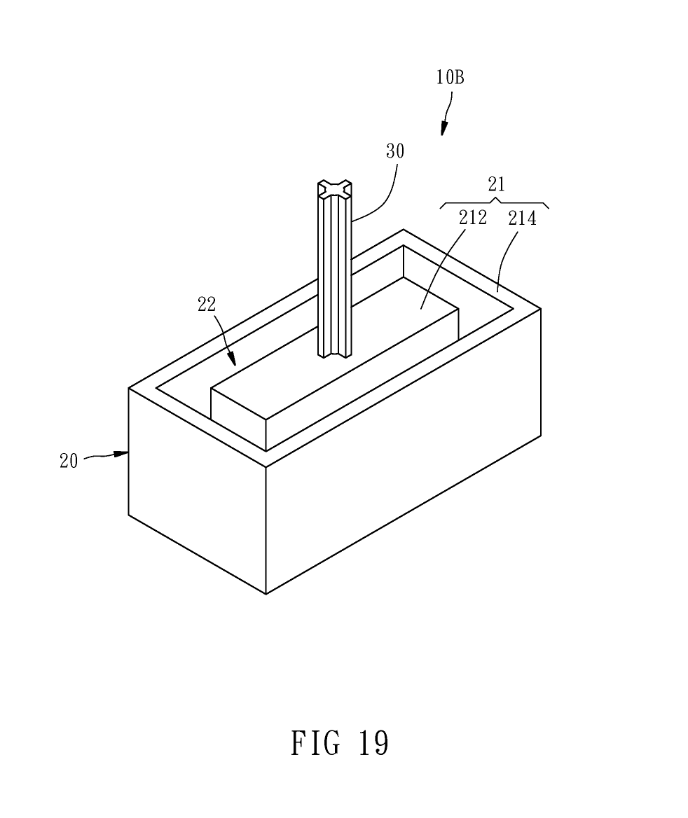

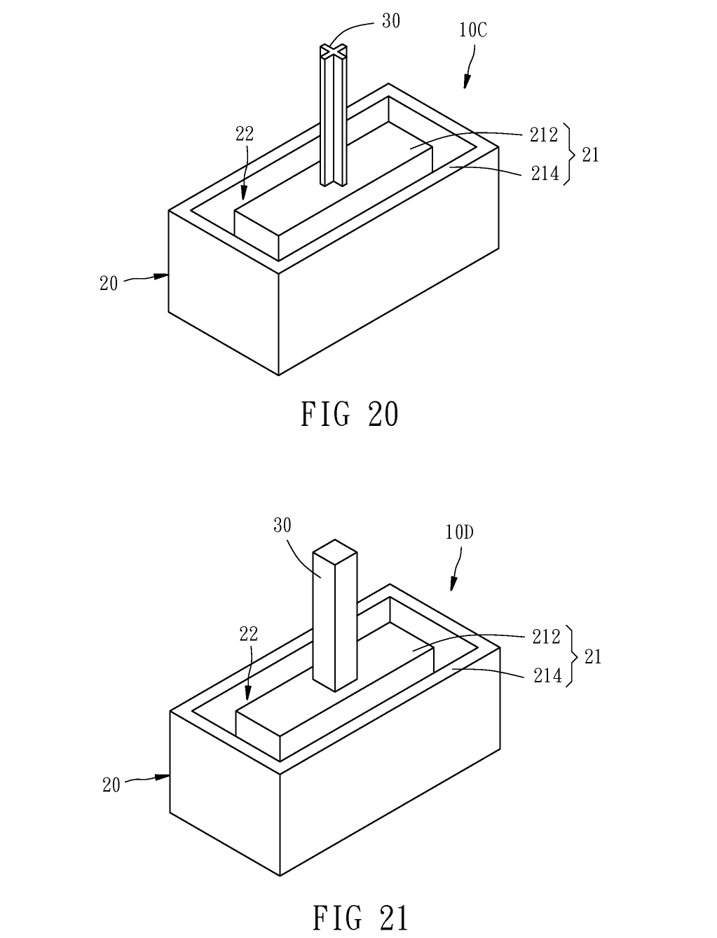

It will be appreciated that the voice coil structure 50, the magnetic path structure 60 and the diaphragm 70 of the speaker are not limited to be circular. For example, the aforesaid components of the speaker might be rectangular; in this case, the aforesaid speaker assembling method can use center positioning jigs 10B, 10C, 10D shown in FIGS. 19-21. In the center positioning jigs 10B, 10C, the positioning column 30 has cross-shaped cross-sections parallel to the top surface 21. In the center positioning jig 10D, the positioning column 30 has rectangular cross-sections parallel to the top surface 21. Compared with the aforesaid positioning column 30 of the center positioning jig 10A, which is shaped as a cylinder and has circular cross-sections parallel to the top surface 21, the positioning column 30 of the center positioning jigs 10B, 10C, 10D can be adapted for not only positioning the center of each component of the speaker but also limiting the angle of each component of the speaker.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A center positioning jig comprising:
a base having a top surface and an annular groove concaved from the top surface, the top surface having a central section surrounded by the annular groove and a peripheral section surrounding the annular groove; and
a positioning column protruding from the central section of the top surface of the base.

2. The center positioning jig as claimed in claim 1, wherein the positioning column has a circular cross-section.

3. The center positioning jig as claimed in claim 1, wherein the positioning column has a cross-shaped cross-section.

4. The center positioning jig as claimed in claim 1, wherein the positioning column has a rectangular cross-section.

5. A speaker assembling method using the center positioning jig as claimed in claim 1, said speaker assembling method comprising the steps of:
a. combining a voice coil structure by means of the center positioning jig and a voice coil jig, wherein a voice coil is positioned on the voice coil jig beforehand, a positioning sheet and the voice coil along with the voice coil jig are sleeved onto the positioning column in order, and then the voice coil jig is removed from the voice coil when the positioning sheet is fastened to the voice coil;
b. combining a magnetic path structure by means of the center positioning jig in a way that a magnet-conductive housing, a magnetic element and a magnet-conductive plate are sleeved onto the positioning column in order, and then removing the center positioning jig from the magnetic path structure;
c. disposing a diaphragm, which has a central part, a surround surrounding the central part and a hole located at the central part, on the top surface of the base in a way that the positioning column passes through the hole, the central part is located at the central section of the top surface of the base, and the surround is located at the annular groove of the base;
d. putting the voice coil structure around the positioning column and fastening the positioning sheet to the central part of the diaphragm;
e. putting the magnetic path structure around the positioning column and combining the magnetic path structure with the diaphragm;
f. removing the center positioning jig from the diaphragm; and
g. fastening a cap at the hole of the diaphragm.

6. The speaker assembling method as claimed in claim 5, wherein the step a comprises the steps of:
a1. disposing the positioning sheet on the central section of the top surface of the base in a way that the positioning column passes through a center hole of the positioning sheet;
a2. sleeving the voice coil onto the voice coil jig in a way that a center hole of the voice coil jig is located at the center of the voice coil;
a3. putting the voice coil around the positioning column in a way that the positioning column passes through the center hole of the voice coil jig, and fastening the voice coil to the positioning sheet; and
a4. removing the voice coil jig from the voice coil structure, and removing the voice coil structure from the center positioning jig.

7. The speaker assembling method as claimed in claim 5, wherein the step b comprises the steps of:
b1. disposing the magnet-conductive housing, which has a bottom wall, an enclosing side wall, an accommodating space defined by the bottom wall and the enclosing side wall, and a center hole located at the bottom wall, on the top surface of the base in a way that the positioning column passes through the center hole of the magnet-conductive housing;
b2. disposing the magnetic element in the accommodating space of the magnet-conductive housing in a way that the positioning column passes through a center hole of the magnetic element, and fastening the magnetic element to the bottom wall of the magnet-conductive housing;
b3. fastening the magnet-conductive plate to the magnetic element in a way that the positioning column passes through a center hole of the magnet-conductive plate; and
b4. removing the magnetic path structure from the center positioning jig.

8. The speaker assembling method as claimed in claim 5, wherein the diaphragm has a supporting part surrounding the surround; in the step c, the supporting part is located at the peripheral section of the base; in the step e, a top edge of the enclosing side wall of the magnet-conductive housing is fastened to the supporting part of the diaphragm.

9. The speaker assembling method as claimed in claim 6, wherein the positioning sheet has an embedding groove surrounding the center hole thereof; the voice coil is fixedly embedded in the embedding groove.

10. The speaker assembling method as claimed in claim 6, wherein the voice coil jig has a bottom plate and a pillar protruding from the bottom plate and having a cylindrical surface; the center hole of the voice coil jig penetrates the bottom plate and the pillar and is concentric with the cylindrical surface of the pillar; in the step a, the voice coil is sleeved onto the voice coil jig at the cylindrical surface thereof and abutted against the bottom plate.

11. A speaker assembling method using the center positioning jig as claimed in claim 1, said speaker assembling method comprising the steps of:
a. disposing a voice coil on a voice coil jig in a way that the voice coil is sleeved onto the voice coil jig and a center hole of the voice coil jig is located at the center of the voice coil;
b. combining a magnet-conductive housing, a magnetic element and a magnet-conductive plate to form a magnetic path structure by means of the center positioning jig in a way that the magnet-conductive housing, the magnetic element and the magnet-conductive plate are sleeved onto the positioning column in order, and then removing the center positioning jig from the magnetic path structure;
c. disposing a diaphragm, which has a central part, a surround surrounding the central part and a hole located at the central part, on the top surface of the base in a way that the positioning column passes through the hole, the central part is located at the central section of the top surface of the base, and the surround is located at the annular groove of the base;
d. putting the voice coil along with the voice coil jig around the positioning column, fastening the voice coil to the central part of the diaphragm, and then removing the voice coil jig from the voice coil;
e. putting the magnetic path structure around the positioning column and combining the magnetic path structure with the diaphragm;
f. removing the center positioning jig from the diaphragm; and
g. fastening a cap at the hole of the diaphragm.

12. The speaker assembling method as claimed in claim 11, wherein the step b comprises the steps of:
b1. disposing the magnet-conductive housing, which has a bottom wall, an enclosing side wall, an accommodating space defined by the bottom wall and the enclosing side wall, and a center hole located at the bottom wall, on the top surface of the base in a way that the positioning column passes through the center hole of the magnet-conductive housing;
b2. disposing the magnetic element in the accommodating space of the magnet-conductive housing in a way that the positioning column passes through a center hole of the magnetic element, and fastening the magnetic element to the bottom wall of the magnet-conductive housing;
b3. fastening the magnet-conductive plate to the magnetic element in a way that the positioning column passes through a center hole of the magnet-conductive plate; and
b4. removing the magnetic path structure from the center positioning jig.

13. The speaker assembling method as claimed in claim 11, wherein the voice coil jig has a bottom plate and a pillar protruding from the bottom plate and having a cylindrical surface; the center hole of the voice coil jig penetrates the bottom plate and the pillar and is concentric with the cylindrical surface of the pillar; in the step a, the voice coil is sleeved onto the voice coil jig at the cylindrical surface thereof and abutted against the bottom plate.
